(19) United States
(12) Patent Application Publication
(10) Pub. No.: US 2024/0103512 A1
(43) Pub. Date: Mar. 28, 2024

(54) REMOTE OPERATION DEVICE, CONTROL METHOD OF REMOTE OPERATION DEVICE, AND NON-TRANSITORY STORAGE MEDIUM

(71) Applicant: HONDA MOTOR CO., LTD., Tokyo (JP)

(72) Inventor: Yuji Takeuchi, Tokyo (JP)

(73) Assignee: HONDA MOTOR CO., LTD., Tokyo (JP)

(21) Appl. No.: 18/238,632

(22) Filed: Aug. 28, 2023

(30) Foreign Application Priority Data
Sep. 28, 2022 (JP) 2022-155268

(51) Int. Cl. G05D 1/00; B60R 25/24

(52) U.S. Cl. CPC G05D 1/0016; B60R 25/24; B60R 2325/205; G05D 2201/0213

(57) ABSTRACT

A remote operation device remotely operates a vehicle, the remote operation device includes: a storage device configured to register identification information associated with a terminal device of a user, and information of a group including the user; and a processor configured to grant authorization for a remote operation on the vehicle to identification information associated with a terminal device of a first user included in the group, based on an operation from the terminal device of the first user. In a case where the processor has granted the authorization for the remote operation, the processor grants the authorization for the remote operation to identification information associated with a terminal device of a second user included in an identical group to the first user.

### CROSS-REFERENCE TO RELATED APPLICATION(S)

This application claims priority to and the benefit of Japanese Patent Application No. 2022-155268 filed on Sep. 28, 2022, the entire disclosure of which is incorporated herein by reference.

### BACKGROUND OF THE INVENTION

### Field of the Invention

The present invention relates to a remote operation device, a control method of the remote operation device, and a non-transitory storage medium.

### Description of the Related Art

Japanese Patent Laid-Open No. 2006-231964 (Patent Literature 1) discloses a technique of identifying a location where a target vehicle of a remote operation was parked last time, determining whether an operation requested by a user is an allowable operation in accordance with the location where the target vehicle of the remote operation was parked last time, and rejecting the operation requested by the user in a case where the operation is not allowable.

In Japanese Patent Laid-Open No. 2006-231964, however, it is not assumed that a plurality of persons share a vehicle. For example, in a case where a vehicle is shared with a plurality of persons by applying the technique of Japanese Patent Laid-Open No. 2006-231964, if a remote operation of one user disables a remote operation on the vehicle, this may impair convenience of another user. In sharing services and the like that are widely used these years, there is a demand for improving the convenience of users, who are a plurality of persons in a predetermined group, share a vehicle.

In consideration of the above issues, the present invention provides a technique capable of improving the convenience of users, who are a plurality of persons, share a vehicle. In addition, one aspect of the present invention contributes to progress of sustainable transportation systems.

### SUMMARY OF THE INVENTION

According to one aspect of the present invention, there is provided a remote operation device that remotely operates a vehicle, the remote operation device comprising: a storage device configured to register identification information associated with a terminal device of a user, and information of a group including the user; and a processor configured to grant authorization for a remote operation on the vehicle to identification information associated with a terminal device of a first user included in the group, based on an operation from the terminal device of the first user, wherein in a case where the processor has granted the authorization for the remote operation, the processor grants the authorization for the remote operation to identification information associated with a terminal device of a second user included in an identical group to the first user.

### BRIEF DESCRIPTION OF THE DRAWINGS

FIG. 1 is a diagram illustrating a configuration example of a vehicle remote operation system;

FIG. 2 is a diagram illustrating hardware configurations of a remote operation device, a vehicle, and a terminal device;

FIG. 3 is a diagram for describing an operation example of the vehicle remote operation system;

FIG. 4 is a diagram for describing an example of a screen displayed on the terminal device;

FIG. 5 is a diagram for describing authorization management information stored in a storage device of the remote operation device;

FIG. 6 is a diagram illustrating a setting example of a group member who belongs to each group;

FIG. 7 is a flowchart illustrating an operation example of the terminal device;

FIG. 8 is a flowchart illustrating an operation example of the remote operation device;

FIG. 9 is a diagram schematically illustrating granting authorization for a remote operation (granting of authorization);

FIG. 10 is a flowchart illustrating an operation example of the remote operation device (limitation on an authorization range);

FIG. 11 is a flowchart illustrating an operation example of the remote operation device (an output of an operation instruction);

FIG. 12 is a flowchart illustrating an operation example of the remote operation device (deletion of the authorization);

FIG. 13 is a flowchart illustrating an operation example of the vehicle (a display of a use code);

FIG. 14 is a flowchart illustrating an operation example of the vehicle (transmission of identification information); and

FIG. 15 is a flowchart illustrating an operation example of the vehicle (an operation based on an instruction).

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Outline of System

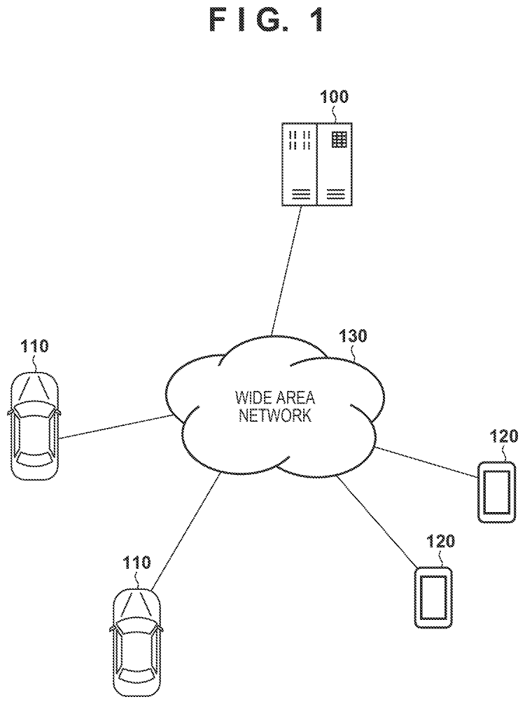

Referring to FIG. 1, a configuration example of a vehicle remote operation system 150 including a remote operation device 100 according to an embodiment will be described. The remote operation device 100 provides the user with a service for remotely operating a vehicle 110 by use of a terminal device 120. Hereinafter, the service for remotely operating the vehicle 110 by use of the terminal device 120 will be referred to as a remote operation service. A remote operation may be performed not only from a location away from the vehicle 110 but also in the vicinity of the vehicle 110 or in the inside of the vehicle 110.

In the remote operation service, the remote operation device 100 remotely operates the vehicle 110 in accordance with a remote operation instruction that has been transmitted from the terminal device 120. The remote operation device 100 may be capable of providing a remote operation service for a plurality of users each having the terminal device 120 individually. In FIG. 1, only two terminal devices 120 are illustrated, but the remote operation device 100 may provide remote operation services for three or more users. In addition, the remote operation device 100 may be capable of performing remote operations on a plurality of vehicles 110. In FIG. 1, only two vehicles 110 are illustrated, but the remote operation device 100 may be capable of performing remote operations on three or more vehicles 110.

The remote operation device 100, the vehicle 110, and the terminal device 120 are each connected with a wide area network 130 such as the Internet. The remote operation device 100 may be connected with the wide area network 130 through a local area network (LAN) (not illustrated). The vehicle 110 may be connected with the wide area network 130 through a cellular network (not illustrated). The terminal device 120 may be connected with the wide area network 130 through a cellular network (not illustrated), or may be connected with the wide area network 130 through a LAN (not illustrated). The remote operation device 100 and the vehicle 110 are capable of communicating with each other through the wide area network 130. The remote operation device 100 and the terminal device 120 are capable of communicating with each other through the wide area network 130. The vehicle 110 and the terminal device 120 may be capable of communicating with each other through the wide area network 130. Instead of this or in addition to this, the vehicle 110 and the terminal device 120 may be capable of directly communicating with each other through short-range communication such as Bluetooth (registered trademark).

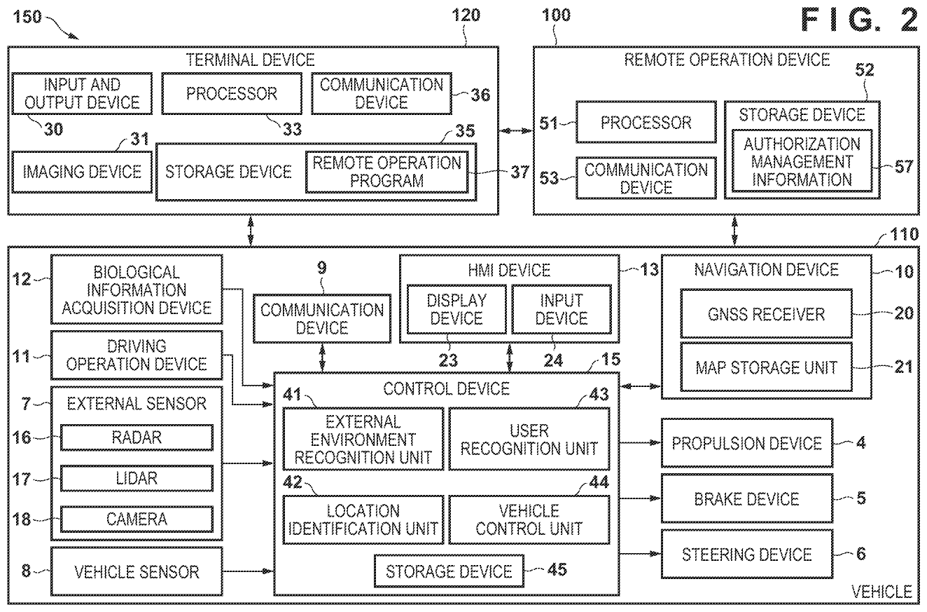

FIG. 2 is a diagram illustrating a hardware configuration of the remote operation device 100, the vehicle 110, and the terminal device 120 in the vehicle remote operation system 150 according to an embodiment.

### Remote Operation Device 100

The remote operation device 100 (server) performs processing related to registration of user information, granting authorization for a remote operation, determination of presence or absence of the authorization for the remote operation, a remote operation instruction that has been received from the terminal device 120, and the like. The remote operation device 100 includes a processor 51, a storage device 52, and a communication device 53.

The processor 51 (arithmetic device) is a general-purpose integrated circuit for performing an operation by the remote operation device 100. The processor 51 may include, for example, a central processing unit (CPU). By reading and executing a program stored in the storage device 52, the processor 51 performs various types of processing related to the vehicle remote operation service. When receiving a registration request for an account for using the remote operation service from the terminal device 120 of a user via the communication device 53, the processor 51 registers user information in the storage device 52. The processor 51 transmits (downloads) a predetermined remote operation program 37 to the terminal device 120 via the communication device 53, in response to the registration request from the terminal device 120 of the user.

The storage device 52 is a device for storing information and software to be used for the operation of the remote operation device 100. The storage device 52 may include a hard disk drive (HDD) or a solid state drive (SSD). The storage device 52 registers the user information, and stores various types of information, and stores, for example, authorization management information 57. The authorization management information 57 is information for managing authorization for performing a remote operation on the vehicle 110. Hereinafter, the authorization for performing the remote operation on the vehicle 110 will be referred to as operation authorization. A specific example of the authorization management information 57 will be described later. The storage device 52 stores a program to be read and executed by the processor 51 and a remote operation program to be provided for the terminal device 120 of the user. In addition, information that has been acquired from the terminal device 120 and the vehicle 110 can be stored via the communication device 53.

The communication device 53 wirelessly transmits and receives various types of information. The communication device 53 is a device for the remote operation device 100 to communicate with an external device (for example, a router or a base station). The communication device 53 may include, for example, a network card. The communication device 53 may perform wireless communication, or may perform wired communication. The communication device 53 may support short-range wireless communication such as Bluetooth (registered trademark). Furthermore, the communication device 53 may support cellular communication, Wi-Fi (registered trademark) communication, and the like. The communication device 53 mediates wireless communication with the control device 15 of the vehicle 110 and a communication device 36 of the terminal device 120.

### Configuration of Vehicle 110

The vehicle 110 includes a propulsion device 4, a brake device 5, a steering device 6, an external sensor 7, a vehicle sensor 8, a communication device 9, a navigation device 10, a driving operation device 11, a biological information acquisition device 12, an interface device (HMI device) 13, and a control device 15.

Each component of the vehicle 110 is connected to be capable of transmitting signals through an in-vehicle communication network such as a controller area network (CAN).

The propulsion device 4 is a device for applying driving force to the vehicle, and includes, for example, a dynamic power supply and a transmission gear. The dynamic power supply includes at least one of an internal combustion engine such as a gasoline engine and an electric motor (motor).

The brake device 5 is a device for applying braking force to the vehicle, and includes, for example, a brake caliper that presses a pad against a brake rotor and an electric cylinder that supplies hydraulic pressure to the brake caliper. The steering device 6 is a device for changing steering angles of wheels, and includes, for example, a rack and pinion mechanism for steering the wheels and an electric motor for activating the rack and pinion mechanism. The steering device 6 includes an electric power steering device. The electric power steering device includes a motor that assists a steering operation or that exerts driving force for automatically steering front wheels, a sensor for detecting a steering angle, and the like. The propulsion device 4, the brake device 5, and the steering device 6 are controlled by the control device 15.

The external sensor 7 is a sensor for detecting an object or the like in the surroundings of the vehicle. The external sensor 7 includes a radar 16, a light detection and ranging (LiDAR) 17, and a camera 18, and outputs a detection result to the control device 15.

The radar 16 is, for example, a millimeter wave radar, and is capable of detecting an object in the surroundings of the vehicle 110 by radio waves, and measuring a distance to the object. A plurality of radars 16 are provided on a circumference of the vehicle 110. For example, one radar 16 is provided at the center of the front part of the vehicle, one radar 16 is provided at each corner of the front part, and one radar 16 is provided at each corner of the rear part.

The LiDAR 17 is capable of detecting an object in the surroundings of the vehicle 110 by light, and measuring a distance to the object. A plurality of LiDARs 17 are provided on a circumference of the vehicle. For example, one LiDAR 17 is provided at each corner portion of the front part of the vehicle, one LiDAR 17 is provided at the center of the rear part, and one LiDAR 17 at each lateral side of the rear part.

The camera 18 is a device for imaging the surroundings of the vehicle 110, and is, for example, a digital camera using a solid-state imaging element such as a CCD or a CMOS. The camera 18 includes a front camera for imaging a forward side of the vehicle 110 and a rear camera for imaging a rearward side.

The vehicle sensor 8 includes a vehicle speed sensor for detecting the speed of the vehicle 110, an acceleration sensor for detecting acceleration, a yaw rate sensor for detecting angular velocity around a vertical axis, an orientation sensor for detecting the orientation of the vehicle 110, and the like. The yaw rate sensor is, for example, a gyro sensor. In addition, the vehicle sensor 8 may include a sensor for detecting a remaining amount of fuel or a battery for activating the propulsion device 4, and a sensor for detecting a working state of the brake device 5 or the like. In addition, the vehicle sensor 8 may include a sensor for detecting a locked state (locking or unlocking) of a door and a sensor for detecting an open or closed state of a window. A detection result of the vehicle sensor 8 is transmitted to the terminal device 120 and the remote operation device 100 via the communication device 9. In the terminal device 120, the detection result of the vehicle sensor 8 may be displayed on a UI screen of the remote operation program 37, in an input and output device 30. Further, in the remote operation device 100, the processor 51 may perform various types of processing such as granting authorization by using the detection result of the vehicle sensor 8.

The communication device 9 provides a function for the vehicle 110 to communicate with the outside. The communication device 9 may support short-range wireless communication such as Bluetooth (registered trademark). Furthermore, the communication device 9 may support cellular communication, Wi-Fi (registered trademark) communication, and the like. The communication device 9 mediates wireless communication between the control device 15 of the vehicle 110, and the terminal device 120 and the remote operation device 100. That is, by using a communication method such as infrared communication or Bluetooth (registered trademark) via the communication device 9, the control device 15 is capable of communicating with the terminal device 120, which is possessed by the user, and with the remote operation device 100.

The navigation device 10 is a device for acquiring a current location of the vehicle, and providing route guidance to a destination or the like, and includes a GNSS receiver 20 and a map storage unit 21. The GNSS receiver 20 identifies the location (latitude and longitude) of the vehicle, based on a signal received from an artificial satellite (a positioning satellite). The map storage unit 21 includes a storage device such as a flash memory or a hard disk, and stores map information.

The driving operation device 11 is provided inside the vehicle, and receives an input operation to be performed by the user to control the vehicle. The driving operation device 11 includes, for example, a steering wheel, an accelerator pedal, a brake pedal, a parking brake device, a shift lever, and a push start switch (engine start button) as driving operation units. The push start switch receives an input operation for starting up the vehicle in accordance with a driving operation from the user. The driving operation device 11 includes a sensor for detecting an operation amount, and outputs a signal indicating the operation amount to the control device 15.

The biological information acquisition device 12 acquires biological information of the user who is present inside the vehicle 110. The biological information acquisition device 12 is, for example, a camera (in-vehicle camera) provided inside the vehicle 110, and acquires an image including the face of the user (in-vehicle user) who is present inside the vehicle 110. The biological information acquisition device 12 is capable of capturing an image including the faces of users seated on front seats (a driver seat and a passenger seat) of the vehicle 110 and users seated on rear seats positioned on a rear side of the front seats. The biological information acquisition device 12 outputs, to the control device 15, the biological information that has been acquired. Note that the biological information acquisition device 12 may be various detection devices for detecting one or more of a fingerprint, a retina, and an iris of the user as biological information.

The interface device 13 (HMI device) provides an interface (human machine interface: HMI) between the control device 15 and the user, notifies the user of various types of information by a display or a sound output, and receives an input operation of the user. The interface device 13 includes a display device 23, which includes a liquid crystal, an organic EL, or the like, and which functions as a touch panel capable of receiving an input operation from the user, and an input device 24 such as a button or a switch.

The control device 15 is an electronic control device (ECU) including a CPU, a nonvolatile memory (ROM), a volatile memory (RAM), and the like. The control device 15 is capable of conducting various type of vehicle control by performing arithmetic processing based on a program, on the CPU. At least a part of each functional unit of the control device 15 may be implemented by hardware such as an LSI, an ASIC, or an FPGA, or may be implemented by a combination of software and hardware.

The control device 15 includes an external environment recognition unit 41, a location identification unit 42, a user recognition unit 43, a vehicle control unit 44, and a storage device 45.

The external environment recognition unit 41 acquires information and the like of another vehicle or an obstacle present in the surroundings of the vehicle 110, based on a detection result of the external sensor 7. For example, the external environment recognition unit 41 acquires information of a location, a size, and the like regarding another vehicle or an obstacle, and information of a display of a traffic signal, a division line of a lane on a road, and a division line (white line or the like) drawn on a road surface of a parking lot or the like. In addition, the external environment recognition unit 41 analyzes the image that has been captured by the camera 18, based on an image analysis method such as pattern matching, and acquires the presence or absence and the size of another vehicle or an obstacle. Furthermore, by using signals from the radar 16 and the LiDAR 17, the external environment recognition unit 41 is capable of calculating the distance to the obstacle, and acquiring the location of the obstacle.

The location identification unit 42 is capable of detecting the location of the vehicle, based a signal from the GNSS receiver 20 of the navigation device 10. In addition to the signal from the GNSS receiver 20, the location identification unit 42 is also capable of acquiring the vehicle speed and the yaw rate from the vehicle sensor 8, and identifying the location and posture of the vehicle by using so-called inertial navigation.

The user recognition unit 43 analyzes the biological information (for example, a face image) that has been acquired by the biological information acquisition device 12, based on an image analysis method such as feature extraction processing, and acquires face information in which features of the user's face are extracted from the face image that has been acquired by the analysis. In a case where a face image including the faces of a plurality of users present inside the vehicle 110 is acquired by the biological information acquisition device 12, the user recognition unit 43 acquires a plurality of pieces of face information in which features of the respective faces of the plurality of users are extracted from the face image.

The processor 51 of the remote operation device 100 refers to the storage device 52, and determines whether the authorization for a remote operation has been granted to identification information associated with the terminal device 120. In a case where the authorization for the remote operation has been granted to the identification information, the processor 51 transmits a remote operation signal from the terminal device 120 to the vehicle 110.

The vehicle control unit 44 controls the vehicle 110 in accordance with the remote operation instruction. For example, the vehicle control unit 44 controls locking (door lock) of a door of the vehicle 110, unlocking (release locking of a door: unlock) of the door, activation of a power system that supplies electric power to each unit of the vehicle 110, activation of the propulsion device 4, and the like. For example, upon receipt of a remote operation instruction to unlock a door, the vehicle control unit 44 unlocks the door. In addition, upon receipt of a remote operation instruction for instructing the activation of the propulsion device 4, the vehicle control unit 44 activates the propulsion device 4. In a case where the propulsion device 4 is an internal combustion engine, the vehicle control unit 44 turns on an ignition device (ignition). Further, the vehicle control unit 44 controls a predetermined operation of the vehicle 110, based on a remote operation instruction of the driving operation device 11.

The storage device 45 includes a flash memory, a hard disk, or the like, and stores various programs to be executed by the control device 15 and various parameters necessary for executing the programs. In addition, the storage device 45 registers various types of information that have been acquired from the remote operation device 100 via the communication device 9. The various types of information include information of the user, which is registered in the authorization management information 57, and which has been acquired from the remote operation device 100.

### Terminal Device 120

The terminal device 120 is a device that can be carried by the user, and is capable of communicating with the remote operation device 100 and the control device 15 of the vehicle 110. The remote operation program 37 provides various functions in vehicle remote operation. The terminal device 120 may be, for example, a mobile device such as a smartphone. As illustrated in FIG. 2, the terminal device 120 includes an input and output device 30, an imaging device 31, a processor 33, a storage device 35, the communication device 36, and the remote operation program 37. The remote operation program 37 is a program that has been acquired from the remote operation device 100. When the remote operation program 37 is executed in the terminal device 120, the input and output device 30 presents information to the user who operates the terminal device 120, and receives an input from the user who operates the terminal device 120. The input and output device 30 functions as, for example, a touch panel. Upon receipt of an input from the user, the input and output device 30 outputs a signal corresponding to such an input into the processor 33. The input and output device 30 functions as a user interface (UI) in various functions related to the vehicle remote operation to be provided by the remote operation program 37. An operation input into the remote operation program 37 and a display of information that has been processed by the remote operation program 37 can be made via the input and output device 30.

The imaging device 31 is capable of capturing an image (a still image, a moving image) in an imaging mode that has been set from the input and output device 30, and the imaging device 31 is, for example, a digital camera including a CMOS and the like. By performing predetermined image processing on the image in which the user who operates the terminal device 120 has been captured, the processor 33 is capable of acquiring features of the face image as the biological information of the user. When registering the account for using the remote operation service in the remote operation device 100, the user may transmit the biological information together with the registration request transmitted from the terminal device 120 to the remote operation device 100, so that the remote operation device 100 may register the identification information (a user ID or a terminal ID) and the biological information in the storage device 52 in association with each other.

The processor 33 controls various types of processing in the terminal device 120. The processor 33 executes a program stored in the storage device 35 to implement various functions related to the vehicle remote operation using the remote operation program 37. The processor 33 controls a display screen on the terminal device 120, and controls, for example, a display of a UI corresponding to various functions related to the vehicle remote operation to be provided by the remote operation program 37.

The storage device 35 is a device for storing information and software to be used for the operation of the terminal device 120. The storage device 52 may include a hard disk drive (HDD) or a solid state drive (SSD). The storage device 52 stores, for example, the remote operation program 37.

The communication device 36 provides a function for the terminal device 120 to communicate with the outside. The communication device 36 may support short-range wireless communication such as Bluetooth (registered trademark). Furthermore, the communication device 36 may support cellular communication, Wi-Fi (registered trademark) communication, and the like.

### Operation Example of System

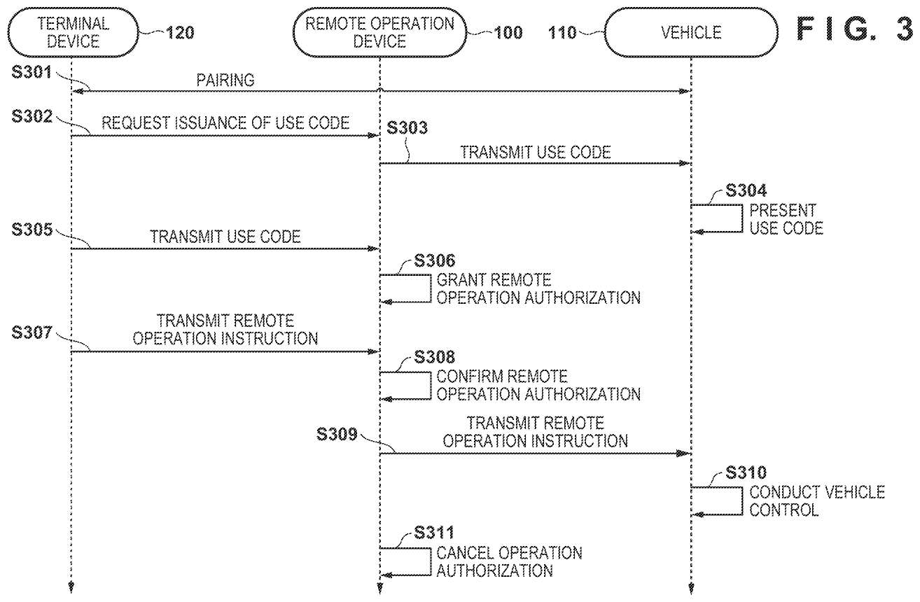

Referring to FIG. 3, an operation example of the vehicle remote operation system 150 including the remote operation device 100 according to an embodiment will be described. Before performing this operation, it is assumed that the user has registered an account for using the remote operation service in the remote operation device 100, and has installed the remote operation program 37 in the terminal device 120 of the user. In addition, it is assumed that the user has registered, in the remote operation program 37, a user ID of the account for using the remote operation service.

In S301, the user makes pairing of the communication device 9 of the vehicle 110 and the communication device 36 of the terminal device 120. Thus, the communication device 9 of the vehicle 110 and the communication device 36 of the terminal device 120 are capable of communicating with each other. The terminal device 120 may acquire a vehicle ID of the vehicle 110 at the time of pairing, and may transmit the vehicle ID to the remote operation device 100 together with its own terminal ID or the user ID registered in the remote operation program 37. The remote operation device 100 may store such a vehicle ID as a vehicle ID of a vehicle, on which the remote operation is to be performed by the terminal device 120 (in a column 503 of the authorization management information 57 to be described later).

Subsequently, in S302 to S306, the user acquires operation authorization for performing the remote operation. Specifically, in S302, the user uses the remote operation program 37, and requests the remote operation device 100 to issue a use code. The use code denotes information necessary to be transmitted to the remote operation device 100 in order to acquire the operation authorization for performing the remote operation.

In S303, the remote operation device 100 generates the use code in response to a request from the user, and transmits the use code to the vehicle 110. For example, the remote operation device 100 may randomly generate a four-digit number as the use code. The remote operation device 100 stores, in the storage device 52, the use code that has been generated and the identification information associated with the terminal device 120 that has requested an issue of the use code, in association with each other, in order to use them in a later step.

In S304, by using the display device 23, the vehicle 110 presents the use code in accordance with the operation that has been performed by the user using the input device 24. The presentation of the use code may be displaying of the use code on the display device 23, may be reproduction of sounds representing the use code from a speaker of the interface device 13, or may be a combination of them. To present the use code, it is necessary to operate the input device 24. Therefore, in order to acquire the use code, the user has to unlock the vehicle 110 by using the key to the vehicle 110.

In S305, the user uses the remote operation program 37, and transmits, to the remote operation device 100, the use code that has been displayed on the display device 23. In S306, the remote operation device 100 grants the remote operation authorization for performing the remote operation to the terminal device 120, on condition that the use code transmitted in S305 matches the use code created in S303 and the use code is received in S305 within a predetermined period of time (for example, within five minutes) after the use code is generated in S303. A valid period may be set for the operation authorization.

The remote operation device 100 may grant the operation authorization to the individual terminal device 120, or may grant the operation authorization to the terminal device 120 on a user basis. It is assumed that a user has a plurality of terminal devices 120. In this case, the remote operation device 100 grants the operation authorization to the terminal device 120, which has been used for transmitting the use code among the plurality of terminal devices 120, and does not have to grant the operation authorization to the other terminal devices 120. The remote operation device 100 may grant the operation authorization to not only the terminal device 120 that has been used for transmitting the use code but also another terminal device 120 among the plurality of terminal devices 120 of the user. In this case, it may be considered that the remote operation device 100 has granted the operation authorization to the user. In the following description, the terminal device 120, to which the operation authorization has been granted, will be referred to as a terminal device 120 having the operation authorization, in some cases. In addition, the user of the terminal device 120, to which the operation authorization has been granted, will be referred to as a user having the operation authorization, in some cases. In the following description, a description will be given with regard to a case where the operation authorization is granted to the individual terminal device 120. However, instead of this, the operation authorization may be granted to the user of the individual terminal device 120. In a similar manner to granting the operation authorization, the remote operation device 100 may cancel the operation authorization of the individual terminal device 120, or may cancel the operation authorization of the terminal device 120 on a user basis.

In S307, the user uses the remote operation program 37 of the terminal device 120 having the operation authorization, and transmits a remote operation instruction for the vehicle 110 to the remote operation device 100. A specific example of the remote operation instruction will be described later. In S308, the remote operation device 100 confirms that the terminal device 120 that has transmitted the remote operation instruction has the operation authorization.

In S309, the remote operation device 100 transmits the remote operation instruction to the vehicle 110 in order to remotely operate the vehicle 110 in accordance with the remote operation instruction from the user.

In S310, the vehicle 110 performs an operation that has been instructed from the remote operation device 100. By repeating the operations of S307 to S310, the user is able to repeatedly instruct the remote operation, as long as the operation authorization is valid.

In S311, the remote operation device 100 cancels the operation authorization in accordance with the remote operation instruction from the user.

By repeating the operations of S307 to S310, the user is able to repeatedly instruct the remote operation, as long as the operation authorization is valid.

In S311, the remote operation device 100 cancels the operation authorization that has been granted to the terminal device 120 in accordance with the valid period of the operation authorization having elapsed. By periodically canceling the operation authorization in this manner, unauthorized use of the remote operation service can be suppressed. The remote operation device 100 may update the valid period of the operation authorization, when S302 to S306 are performed within the valid period.

### Screen Display of Terminal Device 120

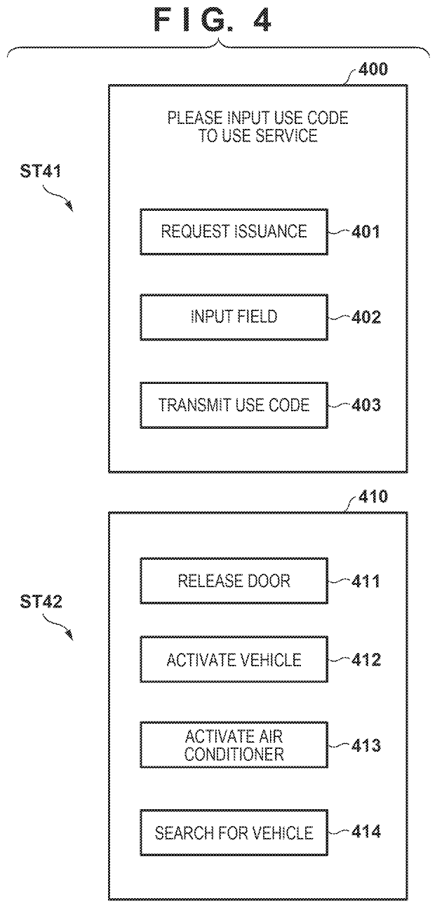

Referring to FIG. 4, an example of a screen displayed on the input and output device 30 of the terminal device 120 by the remote operation program 37 will be described. In addition to a screen 400 and a screen 410, for example, a menu screen or the like for transitioning to these screens may be displayed on the input and output device 30.

ST41 in FIG. 4 illustrates an example of the screen 400 to be used for issuing and transmitting the use code. The screen 400 includes an issue request button 401 for requesting an issue of the use code in the above-described S302. The user uses the input and output device 30, and selects (for example, presses) the issue request button 401, and then a request for issuing the use code is transmitted to the remote operation device 100. An address of the remote operation device 100 may be set beforehand in the remote operation program 37.

The screen 400 further includes a field 402 for inputting the use code and a use code transmission button 403 for transmitting the use code that has been input into the field 402 to the remote operation device 100. The user uses the input and output device 30, inputs the use code into the field 402, and selects (for example, presses) the use code transmission button 403, and then the use code that has been input into the field 402 is transmitted to the remote operation device 100. In an example of ST41 of FIG. 4, the issue request button 401, the field 402, and the use code transmission button 403 are included in an identical screen 400. However, these objects may be arranged on a plurality of screens in a distributed manner.

ST42 in FIG. 4 illustrates an example of the screen 410 to be used for performing the remote operation on the vehicle 110. The screen 410 includes a button 411 for releasing the door lock of (unlocking) the vehicle 110. The user uses the input and output device 30, and selects (for example, presses) the button 411, and then the door of the vehicle 110 is unlocked.

The screen 410 further includes a button 412 for activating a power supply device or the propulsion device 4 of the vehicle 110. The user uses the input and output device 30, and selects (for example, presses) the button 412, and then the power supply or the propulsion device 4 of the vehicle 110 is turned on (for example, a power-on state or an ignition-on state). Thus, the user is able to start moving the vehicle 110. In order to further improve the security, after the button 412 is pressed, the remote operation program 37 may request the user to input an activation code indicated by the display device 23 of the vehicle 110.

The screen 410 further includes a button 413 for activating an air conditioner of the vehicle 110. The user uses the input and output device 30, and selects (for example, presses) the button 413, and then the air conditioner of the vehicle 110 is activated. The remote operation program 37 may provide a remote operation for changing the setting (for example, the temperature) of the air conditioner of the vehicle 110. In addition, a remote operation for activating a defroster may be provided.

The screen 410 further includes a button 414 for changing the state of the vehicle 110 so as to make it easier to find the vehicle 110. The user uses the input and output device 30, and selects (for example, presses) the button 414, and then, for example, the light of the vehicle 110 blinks for a predetermined period of time.

As described above, in a case where the remote operation program 37 includes an unlock operation and a power-on operation as the remote operations, the user is able to start moving the vehicle 110 by using the terminal device 120 instead of the key to the vehicle 110. Therefore, the terminal device 120 can function as a digital key. The remote operation program 37 may include any operation other than the operations described with regard to ST42 of FIG. 4 as a remote operation, or does not have to include a part or all of the operations described with regard to ST42 of FIG. 4. In an example of ST42 of FIG. 4, the buttons 411 to 414 are included in the identical screen 410. However, these objects may be arranged on a plurality of screens in a distributed manner.

### Authorization Management Information

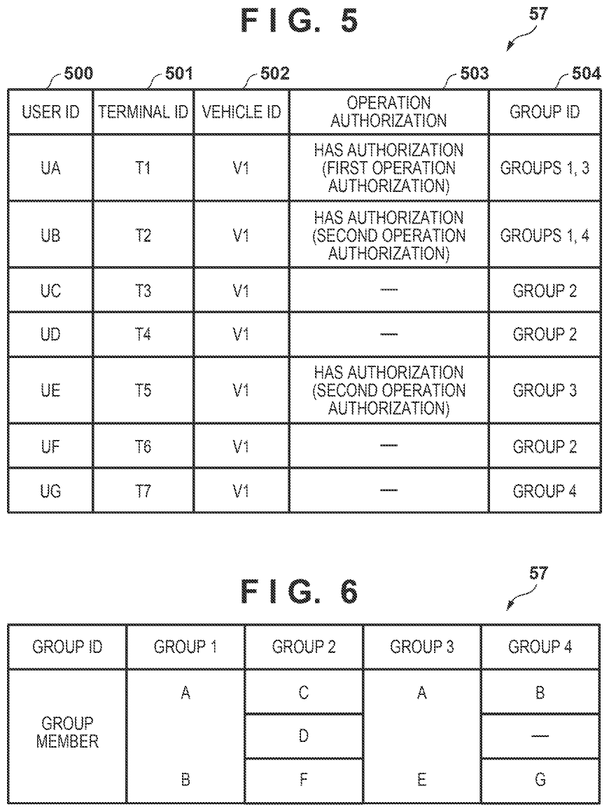

FIG. 5 is a diagram illustrating an example of the authorization management information 57, which is stored in the storage device 52 of the remote operation device 100. The storage device 52 registers the identification information of the user, information of a group including the user, and the like, in the authorization management information 57. In FIG. 5, the operation authorization of each user is managed in a table format. Instead of this, the operation authorization of each user may be managed in another format. In the authorization management information 57, a record is generated for every user who has registered an account for using the remote operation service in the remote operation device 100.

A column 500 (a user ID) represents identification information (that is, the user ID) for uniquely identifying the user. The identification information (the user ID) may be an account name of an account for the user to use the remote operation service. The account name may be a character string (for example, an e-mail address) that has been designated by the user, or may be a unique character string that has been generated by the remote operation device 100. When the user registers the account, the remote operation device 100 adds a record in the authorization management information 57, and registers the user ID in the column 500 of the record.

A column 501 (a terminal ID) represents identification information (that is, the terminal ID) for uniquely identifying the terminal device 120 used by the user. The terminal ID may be, for example, an address of the communication device 36 (a BD address in a case of Bluetooth). The terminal ID may be a serial number of the terminal device 120. The terminal ID may be a character string that has been uniquely allocated to the terminal device 120 by the remote operation device 100. When the account name is input from the user, the remote operation program 37 of the terminal device 120 may transmit the user ID of the terminal device 120 to the remote operation device 100. The remote operation device 100 registers, in the column 501, the terminal ID that has been received. When the remote operation device 100 allocates the terminal ID to the terminal device 120, the remote operation device 100 registers the terminal ID in the column 501, and transmits the terminal ID to the terminal device 120. The terminal device 120 stores the terminal ID that has been received, in order to use it in subsequent processing.

One user may be able to register only one terminal device 120 to be used for the remote operation, or may be able to register a plurality of terminal devices. In a case where one user registers a plurality of terminal devices 120, a plurality of terminal IDs are registered in the column 501.

A column 502 (a vehicle ID) represents identification information (that is, the vehicle ID) for uniquely identifying a vehicle on which the user performs the remote operation. The vehicle ID may be, for example, an IP address that has been assigned to the communication device 9 of the vehicle 110. The vehicle ID may be stored in the vehicle 110. When making pairing in 5301 of FIG. 3, the terminal device 120 may acquire the vehicle ID from the vehicle 110, and may transmit, to the remote operation device 100, the vehicle ID together with the issue request for the use code in 5302. The remote operation device 100 registers, in the column 502, the vehicle ID that has been received.

One user may be able to register only one vehicle 110 on which the user performs the remote operation, or may be able to register a plurality of vehicles. In a case where one user registers a plurality of vehicles 110, a plurality of vehicle IDs are registered in the column 502. In a case where the plurality of vehicle IDs are registered, the remote operation device 100 may acquire the vehicle ID of the vehicle, on which the remote operation is to be performed, together with an instruction of the remote operation.

The column 503 (the operation authorization) represents presence or absence of the operation authorization for the user to perform the remote operation. The remote operation authorization is granted, and then “the presence of the operation authorization” is set in the column 503. The operation authorization may include a plurality of types of operation authorization respectively having different authorization ranges. In addition, the range of the operation authorization may be changed depending on whether the vehicle 110 is in a traveling state.

A column 504 (a group ID) represents identification information (that is, the group ID) for identifying a group to which each user belongs. When the user registers an account for using the remote operation service, the remote operation device 100 is also capable of registering the group ID to which the user belongs, by adding a record in the authorization management information 57.

FIG. 6 is a diagram illustrating the group ID and a setting example of group members who belong to each group. In the authorization management information 57, the group IDs and the group members are managed in a table format, as illustrated in FIG. 6. Instead of the table format, the constitution of the group may be managed in another format.

In an example illustrated in the column 504 of FIG. 5 and FIG. 6, a user A belongs to groups 1 and 3. A user B belongs to groups 1 and 4, and a user E belongs to a group 3. The user A belongs to both the group 1 and the group 3. Users C, D, and F belong to a group 2. A user G belongs to the group 4.

In a group in which the operation authorization is shared with a plurality of users, it is possible to change the range of the operation authorization depending on the member in the group. For example, it is also possible to grant first remote operation authorization that does not limit the range of the operation authorization and second remote operation authorization, by which an operable range (an operation content) is limited as compared with the first remote operation authorization.

For example, in the group 1 and the group 3, the first remote operation authorization may be granted to the user A, and the second remote operation authorization, by which the operable range (the operation content) is limited as compared with the first remote operation authorization, may be granted to the users B and E. The contents of the first remote operation authorization and the second remote operation authorization can be set in a various manner. For example, the first remote operation authorization may be operation authorization that enables operation contents related to contents of control on the traveling and the security of the vehicle 110. In addition, for example, the second remote operation authorization may be limited to contents that do not influence the contents of vehicle control or the security of the vehicle 110, such as a temperature setting of an air conditioner or opening and closing of a power window.

### Operation Example of Terminal Device 120

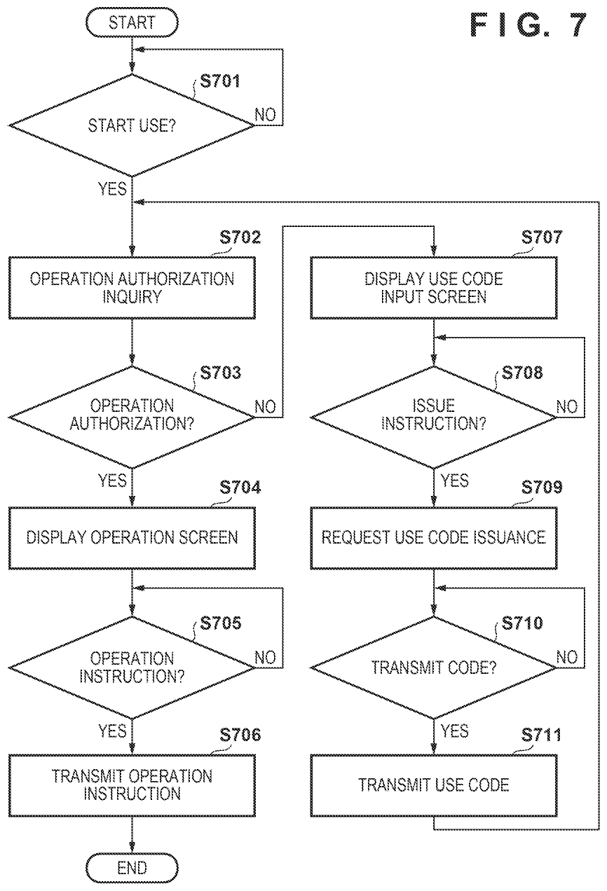

FIG. 7 is a flowchart illustrating an operation example of the terminal device 120. Referring to FIG. 7, an operation example performed by the terminal device 120 will be described. Each step in FIG. 7 may be performed by the processor 33 executing a computer program stored in the storage device 35. Instead of this, some or all of the plurality of steps in FIG. 7 may be performed by a dedicated integrated circuit such as an ASIC. In such a case, the dedicated integrated circuit may operate as a functional unit for performing each step.

In S701, the terminal device 120 determines whether the user has started using the remote operation program 37. In a case where it is determined that the user has started using the remote operation program 37 (“YES” in S701), the terminal device 120 shifts the processing to S702, and in the other case, the processing repeats S701 (“NO” in S701). The terminal device 120 may determine that the user has started using the remote operation program 37, when the remote operation program 37 is activated or when the remote operation program 37 is changed to be active from background.

In S702, the terminal device 120 transmits, to the remote operation device 100, an inquiry about whether the terminal device 120 has the operation authorization. In S703, the terminal device 120 determines whether the terminal device 120 has the operation authorization, based on a result of the inquiry. The terminal device 120 shifts the processing to S704, in a case where it is determined that the terminal device 120 has the operation authorization (“YES” in S703), and in the other case, the terminal device 120 shifts the processing to S707 (“NO” in S703).

In the case where the terminal device 120 has the operation authorization, the terminal device 120 performs the remote operation on the vehicle 110 in S704 to S706. In S704, by using the input and output device 30, the terminal device 120 displays a screen (for example, the screen 410 of ST42 in FIG. 4) for performing the remote operation.

In S705, the terminal device 120 determines whether a remote operation instruction has been acquired from the user using the input and output device 30. In a case where it is determined that the remote operation instruction has been acquired from the user (“YES” in S705), the terminal device 120 shifts the processing to S705, and in the other case, the processing repeats S705 (“NO” in S705). The remote operation instruction may be, for example, pressing of any of the buttons 411 to 414 of ST42 in FIG. 4. In S706, the terminal device 120 transmits, to the remote operation device 100, the remote operation instruction that has been acquired from the user.

In the case where the terminal device 120 does not have the operation authorization, the terminal device 120 acquires the operation authorization on the vehicle 110 in S707 to S711. In S707, by using the input and output device 30, the terminal device 120 displays a screen (for example, the screen 400 of ST41 in FIG. 4) for requesting an issue of the use code.

In S708, the terminal device 120 determines whether an issue instruction has been acquired from the user using the input and output device 30. The issue instruction is an instruction to request an issue of the use code. In a case where it is determined that the issue instruction has been acquired from the user (“YES” in S708), the terminal device 120 shifts the processing to S709, and in the other case, the processing repeats S708 (“NO” in S708). The issue instruction may be, for example, pressing of the issue request button 401 of ST41 in FIG. 4. In S709, the terminal device 120 transmits a request for issuing the use code to the remote operation device 100.

In S710, the terminal device 120 determines whether a code transmission instruction has been acquired from the user using the input and output device 30. The code transmission instruction is an instruction to transmit the use code. In a case where it is determined that the code transmission instruction has been acquired from the user (“YES” in S710), the terminal device 120 shifts the processing to S711, and in the other case, the processing repeats S710 (“NO” in S710). The use code instruction may be, for example, pressing of the issue request button 401 of ST41 in FIG. 4. In S711, the terminal device 120 transmits, to the remote operation device 100, the use code that has been input into the field 402.

Data transmitted from the terminal device 120 to the remote operation device 100 may include the identification information associated with the terminal device 120. The identification information associated with the terminal device 120 may be a user ID, or may be a terminal ID. The user ID may be of the same type with the user ID that has been described in the column 500 of FIG. 5. The terminal ID may be of the same type with the terminal ID that has been described in the column 501 of FIG. 5.

### Operation Example of Remote Operation Device 100

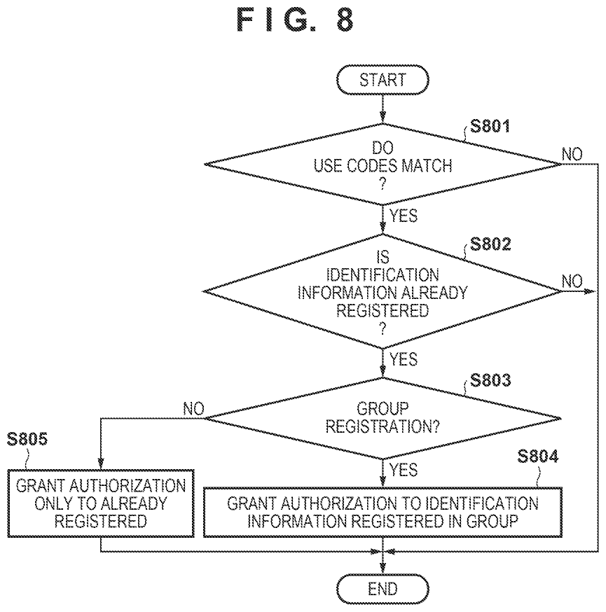

FIGS. 8 and 10 to 12 are flowcharts illustrating an operation example of the remote operation device 100. Each step in FIGS. 8 and 10 to 12 may be performed by the processor 51 executing a computer program stored in the storage device 52. Instead of this, some or all of the plurality of steps in FIGS. 8 and 10 to 12 may be performed by a dedicated integrated circuit such as an ASIC. In such a case, the dedicated integrated circuit may operate as a functional unit for performing each step. Note that the operation example of the remote operation device 100 to be described with reference to FIGS. 8 and 10 to 12 may be performed by the control device 15 of the vehicle 110.

### Granting Authorization for Remote Operation

FIG. 8 is a flowchart illustrating an operation example of the remote operation device 100. Referring to FIG. 8, an operation example of granting the authorization for the remote operation to be performed by the remote operation device 100 will be described.

In S801, the remote operation device 100 determines whether the use code created in S303 matches the use code transmitted in S305. In a case where they match each other (“YES” in S801), the processing proceeds to step S802, and in the other case (“NO” in S801), the processing of granting the authorization ends.

In S802, the remote operation device 100 determines whether the identification information (the user ID or the terminal ID) included in the use code transmitted in S305 is registered in the authorization management information 57. In a case where the authorization is registered (“YES” in S802), the processing proceeds to S803, and in the other case (“NO” in S802), the processing of granting the authorization ends. Note that with regard to acquisition of the identification information (the user ID or the terminal ID), the communication device 9 may acquire the identification information from the terminal device 120 of the user present inside the vehicle 110, and may transmit the identification information to the remote operation device 100.

In S803, the remote operation device 100 refers to the authorization management information 57, and determines whether group registration has been made for the identification information (the user ID or the terminal ID) to which the authorization is to be granted. Specifically, the remote operation device 100 refers to the column 504 of the authorization management information 57, and determines presence or absence of a registered group.

In a case where the group registration has been made (“YES” in S803), the remote operation device 100 shifts the processing to S804, and the remote operation device 100 grants the authorization for the remote operation to the identification information (the user ID or the terminal ID) registered in the group.

The remote operation device 100 grants the authorization for the remote operation on the vehicle 110 to the identification information associated with the terminal device of the first user, based on an operation from the terminal device of the first user included in the group. In a case where the use code (for example, S707 in FIG. 7) that has been indicated on the interface device 13 inside the vehicle 110 matches the use code (for example, S711 in FIG. 7) that has been transmitted from the terminal device 120 of the first user, the remote operation device 100 grants the authorization for the remote operation to the identification information, which is registered in the storage device 52, and which is associated with the terminal device of the first user.

The authorization is to be granted to, for example, the current operator (user) or the last operator (user) at the time of starting up the vehicle 110. The authorization for the remote operation may be granted only to those who belong to an identical group to the current operator or the last operator. For example, when the propulsion device 4 of the vehicle 110 is activated or stopped, the communication device 9 of the vehicle 110 may acquire the identification information associated with the terminal device 120 of the first user present inside the vehicle, and may transmit the identification information to the communication device 53. The communication device 53 may acquire, via the communication device 9 of the vehicle 110, the identification information associated with the terminal device 120 of the first user present inside the vehicle 110, when the vehicle 110 starts up or stops. The processor 51 of the remote operation device 100 may register, in the storage device 52, the identification information that has been acquired by the communication device 53, and may grant the authorization for the remote operation to the identification information registered in the storage device 52.

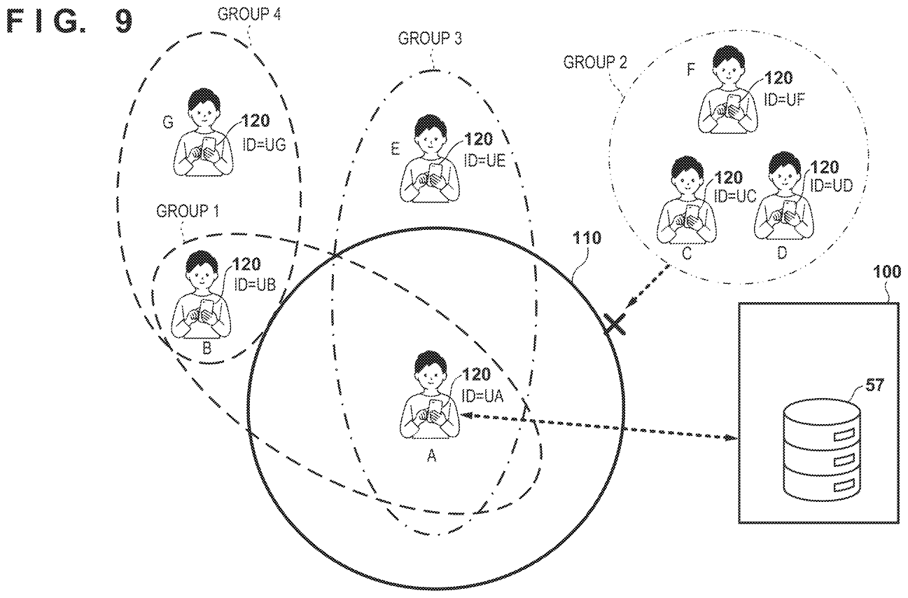

In a case of having given the authorization for the remote operation, the remote operation device 100 grants the authorization for the remote operation to the identification information associated with a terminal device of a second user (for example, the user B in FIG. 9) included in the identical group to the first user (for example, the user A of FIG. 9).

On the other hand, in a case where it is determined in S803 that group registration has not been made (“NO” in S803), the processing proceeds to S805. The remote operation device 100 grants the authorization for the remote operation to the identification information, which is determined in S802 to have been registered, and ends the processing. In this case, the remote operation device 100 grants the authorization for the remote operation to the identification information associated with the terminal device of the first user (for example, the user A of FIG. 9).

FIG. 9 is a diagram schematically illustrating granting the authorization for the remote operation. In FIG. 9, the user A is an in-vehicle user who is present inside the vehicle 110. It is assumed that the use code is transmitted from the terminal device 120 to the remote operation device 100 in accordance with an operation of the user A (an in-vehicle user). In a case where the use code that has been transmitted matches (“YES” in S801) and the identification information (the user ID or the terminal ID) associated with the terminal device 120 of the user A is registered in the authorization management information 57 (“YES” in S802), the remote operation device 100 determines presence or absence of the group registration (S803).

The identification information (the user ID or the terminal ID) associated with terminal device 120 of the user A is ID=UA, and the identification information (ID=UA) is registered in the column 500 of the authorization management information 57 (“YES” in S802). The remote operation device 100 refers to the group ID in the column 504 of the authorization management information 57, and determines the presence or absence of a registered group. In FIG. 5, the groups 1 and 3 are registered for the identification information (ID=UA).

In the group 1, the identification information associated with the terminal device 120 of the user B, that is, ID=UB is registered. In the group 3, the identification information associated with the terminal device 120 of the user E, that is, ID=UE is registered.

In a case of granting the authorization for the remote operation to the identification information (ID=UA), the remote operation device 100 grants the authorization to another piece of identification information (ID=UB) registered in the group 1 and another piece of identification information (ID=UE) registered in the group 3.

Note that the remote operation device 100 does not grant the authorization for the remote operation to identification information (ID=UG) associated with a terminal device of a fourth user (for example, the user G) who is included in the identical group to the second user (for example, the group 4), and who is not included in the identical group to the first user. Even though the authorization for the remote operation has been granted to the identification information (ID=UB) of the user B, the authorization for the remote operation is not granted to the identification information (ID=UG) associated with the terminal device 120 of a user who is not included in the identical group to the first user (user A). That is, the authorization for the remote operation is not granted to the identification information (ID=UG) associated with the terminal device 120 of the user Gin the identical group 4 to the user B.

The authorization for the remote operation is not granted to the user C (ID=UC), the user D (ID=UD), or the user F (ID=UF), who belong to the group 2. The remote operation device 100 rejects a request for the remote operation that has been received from the terminal device 120 of the third user (for example, the user C, D, or F), who is not registered in the identical group to the group including the first user, in the storage device 52. The remote operation device 100 rejects the request for the remote operation that has been received from the terminal device of the third user to whom the authorization for the remote operation has not been granted in the authorization management information 57.

### Limitation on Authorization Range

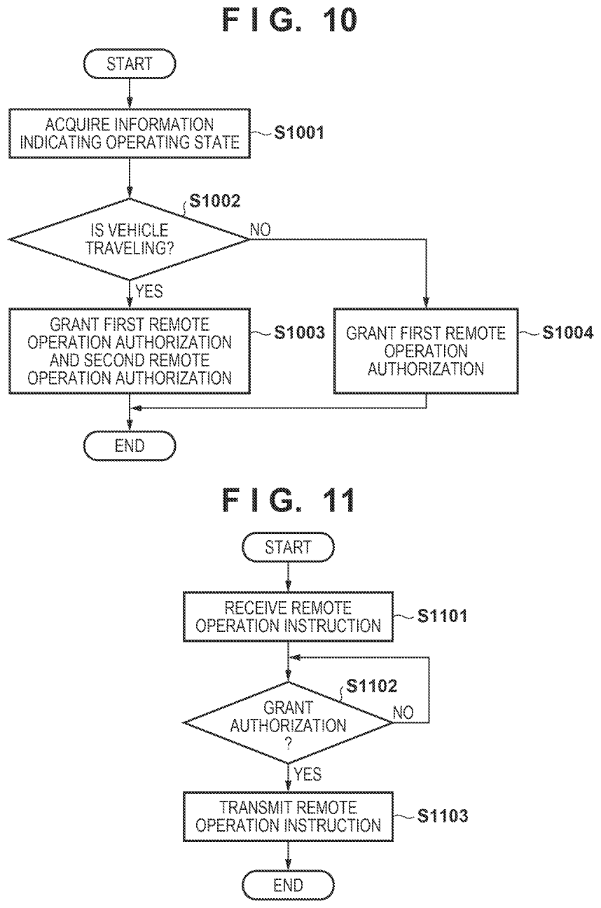

The remote operation device 100 is capable of changing the range of the operation authorization in accordance with an operating state of the vehicle 110 (an activating state or a stopped state of the propulsion device 4). FIG. 10 is a flowchart illustrating an operation example of the remote operation device 100. Referring to FIG. 10, an operation example of limiting the authorization range to be performed by the remote operation device 100 will be described.

In S1001, the communication device 53 of the remote operation device 100 acquires state information indicating a traveling state or a stopped state of the vehicle 110.

In S1002, the remote operation device 100 determines whether the vehicle 110 is in the traveling state or in the stopped state, based on the state information. The remote operation device 100 advances the processing to S1003, in a case where the vehicle 110 is in the traveling state (“YES” in S1002).

In S1003, in the traveling state of the vehicle 110, the remote operation device 100 grants the first remote operation authorization to the identification information associated with the terminal device of the first user, and grants the second remote operation authorization, by which an operable function is limited as compared with the first remote operation authorization, to the identification information associated with the terminal device of the second user. For example, the remote operation device 100 grants the first remote operation authorization to the identification information (ID=UA) associated with the terminal device 120 of the first user (for example, the user A of FIG. 9). In addition, the remote operation device 100 grants the second remote operation authorization, by which an operable function is limited as compared with the first remote operation authorization, to the identification information (ID=UB) associated with the terminal device 120 of the second user (for example, the user B in FIG. 9). The first remote operation authorization may be, for example, operation authorization that enables operation contents related to the contents of the vehicle control and the security. In addition, for example, the second remote operation authorization may be limited to the contents that do not influence the contents of the vehicle control or the security of the vehicle 110, such as a temperature setting of the air conditioner or opening and closing of the power window.

On the other hand, in a case where the vehicle 110 is determined to be in the stopped state in the determination of S1002 (“NO” in S1002), the remote operation device 100 advances the processing to S1004. In S1004, in the stopped state of the vehicle 110, the remote operation device 100 grants the first remote operation authorization to the identification information associated with the terminal device of the first user and the identification information associated with the terminal device of the second user.

For example, the remote operation device 100 grants the first remote operation authorization commonly to the identification information (ID=UA) associated with the terminal device 120 of the first user and the identification information (ID=UB) associated with the terminal device 120 of the second user.

### Output of Remote Operation Instruction

FIG. 11 is a flowchart illustrating an operation example of the remote operation device 100. Referring to FIG. 11, an operation example of outputting a remote operation instruction to be performed by the remote operation device 100 will be described. The output of the remote operation instruction denotes processing of transmitting, to the vehicle 110 to be operated, the remote operation instruction that has been received from the terminal device 120.

In S1101, the remote operation device 100 receives the remote operation instruction from the terminal device 120.

In S1102, the remote operation device 100 refers to the authorization management information 57, and determines presence or absence of the authorization for the remote operation, based on the identification information (the user ID or the terminal ID) included in the remote operation instruction. In a case where it is determined that the user has the authorization for the remote operation (“YES” in S1102), the processing proceeds to S1103, and in the other case (“NO” in S1102), the processing repeats S1102.

In S1103, the remote operation device 100 refers to the authorization management information 57, and identifies the vehicle 110 to be operated (for example, vehicle ID=V1 in FIG. 5), based on the identification information included in the remote operation instruction. Then, the remote operation device 100 transmits the remote operation instruction (a remote operation signal) to the vehicle 110 that has been identified, in accordance with the remote operation instruction.

### Deletion of Remote Operation Authorization

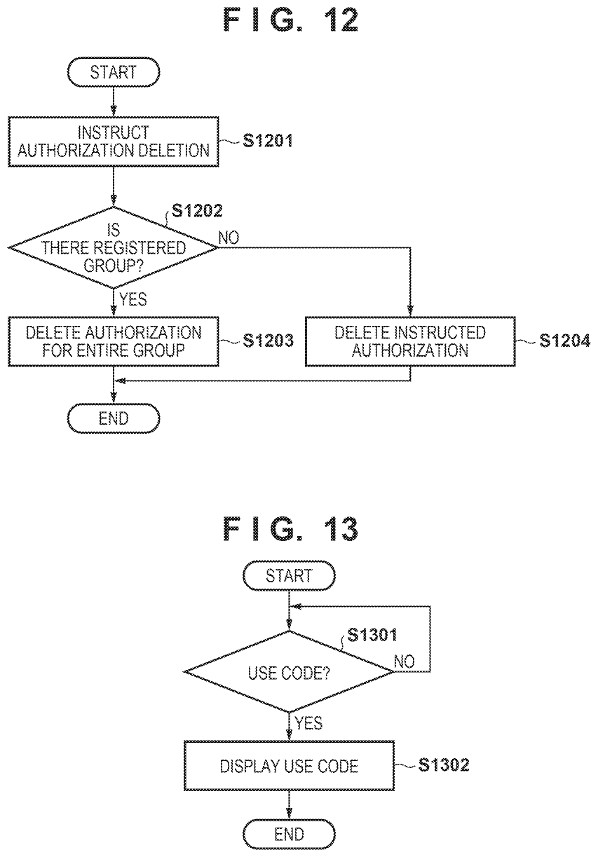

FIG. 12 is a flowchart illustrating an operation example of the remote operation device 100. Referring to FIG. 12, an operation example of deleting the authorization for the remote operation to be performed by the remote operation device 100 will be described.

In S1201, the remote operation device 100 receives an instruction to delete the authorization for the remote operation from the terminal device 120. The remote operation device 100 refers to the authorization management information 57 (for example, the column 503 of FIG. 5), and identifies the authorization for the remote operation to be deleted, based on the identification information (the user ID or the terminal ID) included in the instruction to delete the authorization.

In S1202, the remote operation device 100 refers to the authorization management information 57 (for example, the column 504 of FIG. 5), and determines whether the group registration has been made for the identification information from which the authorization for the remote operation is to be deleted. In a case where it is determined that the group registration has been made (“YES” in S1202), the processing proceeds to S1203.

In S1203, the remote operation device 100 deletes the authorization for the remote operation of the entire group. For example, when the user B illustrated in FIG. 9 transmits, to the remote operation device 100, an instruction to delete the authorization for the remote operation from the terminal device 120, the remote operation device 100 deletes the authorization for the remote operation associated with the terminal devices 120 of all the users (A and B) in the group 1 to which the user B belongs. The authorization for the remote operation associated with the terminal device 120 of the user E in the group 3 remains without being deleted.

In addition, when the user A illustrated in FIG. 9 transmits the instruction to delete the authorization for the remote operation from the terminal device 120 to the remote operation device 100, the remote operation device 100 deletes the authorization for the remote operation associated with the terminal devices 120 of all the users in the group 1 (A and B) and all the users in the group 3 (A and E) to which the user A belongs.

On the other hand, in a case where the group registration has not been made (“NO” in S1202), the processing proceeds to S1204. In S1204, the remote operation device 100 deletes the authorization for the remote operation identified in S1201.

### Modifications

In addition, when a user whose authorization for the remote operation is not registered in the storage device 52 activates the propulsion device 4 of the vehicle 110, the remote operation device 100 may delete the identification information and the group information in which the authorization for the remote operation is registered in the storage device 52. For example, when the user C who belongs to the group 2 in FIG. 9 gets in the vehicle 110 and activates the propulsion device 4, the remote operation device 100 may delete the identification information and the group information of the users A, B, and E who belong to the groups 1 and 3, to which the authorization for the remote operation has been granted.

### Operation Example of Vehicle 110

FIGS. 13 to 15 are flowcharts illustrating an operation example of the vehicle 110. Each step in FIGS. 13 to 15 may be performed by the processor 51 executing a computer program stored in the storage device 45. Instead of this, some or all of the plurality of steps in FIGS. 13 to 15 may be performed by a dedicated integrated circuit such as an ASIC. In such a case, the dedicated integrated circuit may operate as a functional unit for performing each step.

### Display of Use Code

FIG. 13 is a flowchart illustrating an operation example of the vehicle 110. Referring to FIG. 13, an operation example of displaying the use code to be performed by the vehicle 110 will be described. In S1301, the vehicle 110 determines whether the use code transmitted in S303 (FIG. 3) has been received from the remote operation device 100. In a case where it is determined that the use code has been received (“YES” in S1301), the vehicle 110 shifts the processing to S1302, and in the other case, the processing repeats S1301 (“NO” in S1301).

In S1302, by using the display device 23, the vehicle 110 displays the use code in accordance with an operation on the input device 24 by the user.

### Transmission of Identification Information

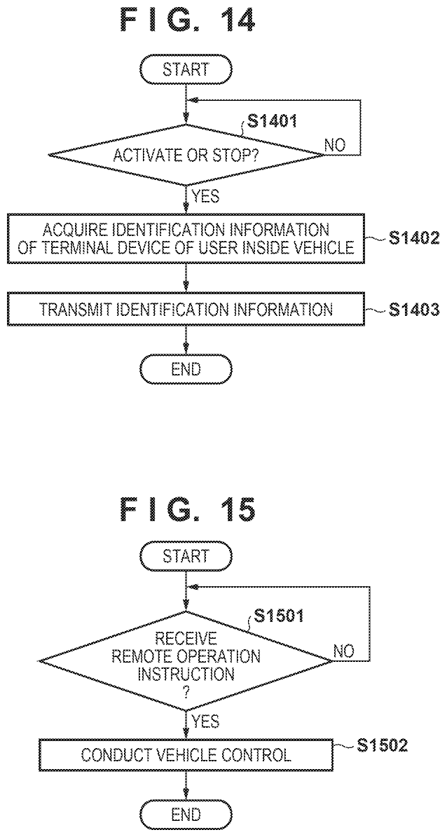

FIG. 14 is a flowchart illustrating an operation example of the vehicle 110. Referring to FIG. 14, an operation example of transmitting the identification information to be performed by the vehicle 110 will be described. In the operation illustrated in FIG. 14, the vehicle 110 transmits, to the remote operation device 100, the identification information associated with the terminal device 120 of the current operator (user) or the last operator (user) at the time of starting up.

In S1401, the vehicle control unit 44 of the vehicle 110 determines whether to activate or stop the propulsion device 4, by controlling ON or OFF of the ignition device (ignition). In a case where it is determined that the vehicle 110 has started up or stopped (“YES” in S1401), the processing proceeds to S1402, and in the other case (“NO” in S1401), the processing repeats S1401.

In S1402, the vehicle 110 acquires the identification information (the user ID or the terminal ID) associated with the terminal device 120 inside the vehicle 110. The identification information (the user ID or the terminal ID) may be acquired by use of the communication device 9 of the vehicle 110. The identification information associated with the terminal device 120 may be the terminal ID of the terminal device 120, or may be the user ID of the user of the terminal device 120. In a case where a plurality of terminal devices 120 are present inside the vehicle 110, the vehicle 110 may acquire the identification information (the user ID or the terminal ID) from each of the plurality of terminal devices 120.

In S1403, the vehicle 110 transmits the identification information (the user ID or the terminal ID) acquired in S1402 to the remote operation device 100. This identification information is used for the registration in the authorization management information 57 (for example, FIG. 5) and the determination of granting the authorization for the remote operation (for example, S802 in FIG. 8). Note that in the above example, the description has been given with regard to an example in which the identification information associated with the terminal device 120 inside the vehicle 110 is acquired, when the vehicle 110 starts up or stops. However, other than that, the vehicle 110 may transmit, to the remote operation device 100, the identification information associated with the terminal device 120 that has moved together with the vehicle 110 for a predetermined period of time.

The communication device 53 of the remote operation device 100 acquires, from the vehicle 110, the identification information (the user ID or the terminal ID) associated with the terminal device 120 of the first user who is present inside the vehicle 110, when the vehicle 110 starts up or stops. The processor 51 of the remote operation device 100 registers the identification information (the user ID or the terminal ID) that has been acquired by the communication device 53 in the storage device 52, and grants the authorization for the remote operation to the identification information (the user ID or the terminal ID) that has been registered in the storage device 52.

### Operation Based on Remote Operation Instruction

FIG. 15 is a flowchart illustrating an operation example of the vehicle 110. Referring to FIG. 15, an operation example of the vehicle control based on a remote operation instruction to be performed by the vehicle 110 will be described.

In the operation illustrated in FIG. 15, the vehicle 110 operates in accordance with an instruction for the remote operation. In S1501, the vehicle 110 determines whether the remote operation instruction transmitted in S309 has been received from the remote operation device 100 via the communication device 9. In a case where it is determined that the remote operation instruction has been received (“YES” in S1501), the vehicle 110 shifts the processing to S1502, and in the other case (“NO” in S1501), the processing repeats S1501.

In S1502, the vehicle 110 conducts vehicle control in accordance with the remote operation instruction. The vehicle control unit 44 controls the vehicle 110 in accordance with the remote operation instruction. For example, the vehicle control unit 44 controls locking (door lock) of a door of the vehicle 110, unlocking (release locking of a door: unlock) of the door, activation of a power system that supplies electric power to each unit of the vehicle 110, activation of the propulsion device 4, and the like.

### Other Embodiments

In addition, the remote operation program that implements one or more functions that have been described in each embodiment is supplied to a terminal device via a network or a storage medium, and one or more processors in a system or a computer of the device is capable of reading and executing the remote operation program. The present invention is also enabled according to such an aspect.

### Summary of Embodiments

The above embodiments disclose at least a following remote operation device, a control method of the remote operation device, and a non-transitory storage medium.
(Item 1) The remote operation device according to the above embodiments is a remote operation device (100) that remotely operates a vehicle, the remote operation device (100) including:
   a storage device (52) configured to register identification information associated with a terminal device of a user, and information of a group including the user; and
   a processor (51) configured to grant authorization for a remote operation on the vehicle to identification information associated with a terminal device of a first user included in the group, based on an operation from the terminal device of the first user,
   wherein in a case where the processor (51) has granted the authorization for the remote operation, the processor (51) grants the authorization for the remote operation to identification information associated with a terminal device of a second user included in an identical group to the first user.

According to the remote operation device of Item 1, the convenience of the users, who share the vehicle with a plurality of persons, can be improved. For example, the users included in the identical group are highly likely to move in relation to each other, such as simultaneously moving. Therefore, by conducting group management for the authorization for the remote operation on the vehicle, the convenience of users who belong to the identical group can be improved.
(Item 2) The processor (51) rejects a request for the remote operation received from a terminal device of a third user who is not registered in the identical group including the first user in the storage device (52).

According to the remote operation device of Item 2, by rejecting the request for the remote operation that has been received from the terminal device of the third user, who is not registered in the identical group, the security for the authorization for the remote operation can be improved.
(Item 3) In a case where a use code indicated on an interface device inside the vehicle matches a use code transmitted from the terminal device of the first user,
   the processor (51) grants the authorization for the remote operation to the identification information registered in the storage device (52) and associated with the terminal device of the first user.

According to the remote operation device of Item 3, by setting matching of the use codes as a precondition for granting the authorization for the remote operation, the security for the remote operation authorization can be improved.
(Item 4) The remote operation device (100) according to the above embodiments further includes a communication device (53) configured to acquire, from the vehicle, the identification information associated with the terminal device of the first user who is present inside the vehicle, when the vehicle starts up or stops,
   wherein the processor (51)
   registers, in the storage device (52), the identification information acquired by the communication device (53), and
   grants the authorization for the remote operation to the identification information registered in the storage device (52).

According to the remote operation device (100) of Item 4, the authorization for the remote operation can be granted to the identification information associated with the terminal device of either the current user at the time of starting up the vehicle or the last user.
(Item 5) The processor (51) outputs a signal for operating the vehicle, based on a request for the remote operation received from a terminal device having the identification information to which the authorization for the remote operation is granted.

According to the remote operation device (100) of Item 5, the vehicle can be remotely operated, based on the request for the remote operation that has been transmitted from the terminal device having the identification information to which the authorization for the remote operation has been granted.
(Item 6) The communication device (53) acquires state information indicating either a traveling state or a stopped state of the vehicle, and
   in the traveling state of the vehicle, the processor (51)
   grants first remote operation authorization to the identification information associated with the terminal device of the first user, and
   grants second remote operation authorization, by which an operable function is limited as compared with the first remote operation authorization, to the identification information associated with the terminal device of the second user.

According to the remote operation device (100) of Item 6, different rages of the operation authorization can be set in the authorization for the remote operation to be granted in the traveling state of the vehicle. For example, the operation authorization that enables operation contents related to contents of control on the traveling and the security of the vehicle can be set for the identification information associated with the terminal device of the first user. In addition, for example, the contents that do not influence the contents of the vehicle control or the security of the vehicle, such as a temperature setting of the air conditioner or opening and closing of the power window, can be set for the identification information associated with the terminal device of the second user.
(Item 7) In the stopped state of the vehicle, the processor (51) grants the first remote operation authorization to the identification information associated with the terminal device of the first user and the identification information associated with the terminal device of the second user.

According to the remote operation device (100) of Item 7, the first remote operation authorization that is common can be granted to the identification information associated with the terminal device of each user in the group.
(Item 8) The remote operation device (100) according to the above embodiments further includes a communication device (53) configured to acquire, from the vehicle, the identification information associated with the terminal device of the first user present inside the vehicle, when the vehicle starts up, wherein when the vehicle starts up, in a case where the authorization for the remote operation is not granted to the identification information of the first user, the processor (51) deletes the identification information, the authorization for the remote operation of which is registered in the storage device (52), and the information of the group.

According to the remote operation device (100) of Item 8, the authorization for the remote operation is to be granted to the identification information associated with the terminal device of a new current user or a lastly operated user, and the information that has been registered for the past user can be deleted. By deleting the information that has been registered for the past user, the past user becomes unable to operate the vehicle, so that the security for the operation on the vehicle can be improved.
(Item 9) In a case where either the first user or the second user has deleted the authorization for the remote operation granted, and the processor (51) deletes the authorization for the remote operation granted to the identification information associated with the terminal devices of the first user and the second user who belong to the identical group.

According to the remote operation device (100) of Item 9, granting the authorization for the remote operation can be managed on a group basis. For example, in a case where the authorization for the remote operation remains for some users, even though they are not authorized users due to resale of the vehicle or the like, a state in which the remote operation is enabled for some users may occur. In order to prevent such a state in advance, by collectively deleting the granted authorization for the remote operation on a group basis, the security for the operation on the vehicle can be improved.
(Item 10) In a case where a plurality of groups to which the first user belongs are registered in the storage device (52),
   in the case where the processor (51) has granted the authorization for the remote operation, the processor (51) grants the authorization for the remote operation to identification information associated with terminal devices of each user included in the plurality of groups to which the first user belongs.

According to the remote operation device (100) of Item 10, the convenience of the users, who share the vehicle with a plurality of persons, can be improved. For example, the users included in the identical group are highly likely to move in relation to each other, such as simultaneously moving. Therefore, by conducting group management for the authorization for the remote operation on the vehicle, the convenience of users who belong to the identical group can be improved.
(Item 11) The processor (51) does not grant the authorization for the remote operation to identification information associated with a terminal device of a fourth user, who is included in the identical group to the second user and is not included in the identical group to the first user.

According to the remote operation device (100) of Item 11, the range of granting the authorization for the remote operation can be suppressed from being extended in a chain manner.
(Item 12) The control method of the remote operation device according to the above embodiments is a control method of a remote operation device (100) that remotely operates a vehicle, the control method including:
   registering, in a storage device (52), identification information associated with a terminal device of a user, and information of a group including the user;
   granting, by a processor (51), authorization for a remote operation on the vehicle to identification information associated with a terminal device of a first user included in the group, based on an operation from the terminal device of the first user; and
   in a case where the processor (51) has granted the authorization for the remote operation, granting, by the processor (51), the authorization for the remote operation to identification information associated with a terminal device of a second user included in an identical group to the first user.

According to the control method of the remote operation device (100) of Item 12, the convenience of the users, who share the vehicle with a plurality of persons, can be improved. For example, the users included in the identical group are highly likely to move in relation to each other, such as simultaneously moving. Therefore, by conducting group management for the authorization for the remote operation on the vehicle, the convenience of users who belong to the identical group can be improved.
(Item 13) The non-transitory storage medium according to the above embodiments is a non-transitory storage medium in which is stored a program that causes a computer to execute the steps of the control method according to item 12.

According to the non-transitory storage medium of Item 13, a program for causing a computer to execute each step in the control method of the remote operation device (100) can be provided.

The invention is not limited to the foregoing embodiments, and various variations/changes are possible within the spirit of the invention.

What is claimed is:

1. A remote operation device that remotely operates a vehicle, the remote operation device comprising:
a storage device configured to register identification information associated with a terminal device of a user, and information of a group including the user; and
a processor configured to grant authorization for a remote operation on the vehicle to identification information associated with a terminal device of a first user included in the group, based on an operation from the terminal device of the first user,
wherein in a case where the processor has granted the authorization for the remote operation, the processor grants the authorization for the remote operation to identification information associated with a terminal device of a second user included in an identical group to the first user.

2. The remote operation device according to claim 1, wherein the processor rejects a request for the remote operation received from a terminal device of a third user who is not registered in the identical group including the first user in the storage device.

3. The remote operation device according to claim 1, wherein
in a case where a use code indicated on an interface device inside the vehicle matches a use code transmitted from the terminal device of the first user,
the processor grants the authorization for the remote operation to the identification information registered in the storage device and associated with the terminal device of the first user.

4. The remote operation device according to claim 1, further comprising a communication device configured to acquire, from the vehicle, the identification information associated with the terminal device of the first user who is present inside the vehicle, when the vehicle starts up or stops,
wherein the processor
registers, in the storage device, the identification information acquired by the communication device, and
grants the authorization for the remote operation to the identification information registered in the storage device.

5. The remote operation device according to claim 1, wherein the processor outputs a signal for operating the vehicle, based on a request for the remote operation received from a terminal device having the identification information to which the authorization for the remote operation is granted.

6. The remote operation device according to claim 4, wherein the communication device acquires state information indicating either a traveling state or a stopped state of the vehicle, and
in the traveling state of the vehicle, the processor
grants first remote operation authorization to the identification information associated with the terminal device of the first user, and
grants second remote operation authorization, by which an operable function is limited as compared with the first remote operation authorization, to the identification information associated with the terminal device of the second user.

7. The remote operation device according to claim 6, wherein in the stopped state of the vehicle,
the processor grants the first remote operation authorization to the identification information associated with the terminal device of the first user and the identification information associated with the terminal device of the second user.

8. The remote operation device according to claim 1, further comprising a communication device configured to acquire, from the vehicle, the identification information associated with the terminal device of the first user present inside the vehicle, when the vehicle starts up,
wherein when the vehicle starts up, in a case where the authorization for the remote operation is not granted to the identification information of the first user, the processor deletes the identification information, the authorization for the remote operation of which is registered in the storage device, and the information of the group.

9. The remote operation device according to claim 1, wherein in a case where either the first user or the second user has deleted the authorization for the remote operation granted, and
the processor deletes the authorization for the remote operation granted to the identification information associated with the terminal devices of the first user and the second user who belong to the identical group.

10. The remote operation device according to claim 1, wherein in a case where a plurality of groups to which the first user belongs are registered in the storage device,
in the case where the processor has granted the authorization for the remote operation, the processor grants the authorization for the remote operation to identification information associated with terminal devices of each user included in the plurality of groups to which the first user belongs.

11. The remote operation device according to claim 1, wherein the processor does not grant the authorization for the remote operation to identification information associated with a terminal device of a fourth user, who is included in the identical group to the second user and is not included in the identical group to the first user.

12. A control method of a remote operation device that remotely operates a vehicle, the control method comprising:
registering, in a storage device, identification information associated with a terminal device of a user, and information of a group including the user;
granting, by a processor, authorization for a remote operation on the vehicle to identification information associated with a terminal device of a first user included in the group, based on an operation from the terminal device of the first user; and
in a case where the processor has granted the authorization for the remote operation, granting, by the processor, the authorization for the remote operation to identification information associated with a terminal device of a second user included in an identical group to the first user.

13. A non-transitory storage medium in which is stored a program that causes a computer to execute the steps of the control method according to claim 12.
